(19) United States
(12) Patent Application Publication
(10) Pub. No.: US 2017/0124493 A1
(43) Pub. Date: May 4, 2017

(54) BUSINESS PROCESS MANAGEMENT SYSTEM AND BUSINESS PROCESS MANAGEMENT METHOD

(71) Applicant: Institute For Information Industry, Taipei (TW)

(72) Inventor: Kai-Hsuan CHAN, Keelung City (TW)

(21) Appl. No.: 14/942,685

(22) Filed: Nov. 16, 2015

(30) Foreign Application Priority Data
Nov. 2, 2015 (TW) 104136011

(51) Int. Cl. G06Q 10/06

(52) U.S. Cl. CPC G06Q 10/0633

(57) ABSTRACT

The present invention relates to a business process management system. The business process management system includes a database, a memory device and a business process management engine. The database is configured to store a business process model and configured to create storage fields in advance for a plurality of process variables included in the business process model according to at least one artifact corresponding to the business process model. The at least one artifact records an association between the process variables and the created storage fields. The business process management engine is configured to copy the business process model from the database to the memory device to execute the business process model at the memory device and configured to simultaneously store variable values corresponding to the process variables from the memory to the created storage fields of the database according to the association during executing the business process model.

### PRIORITY

This application claims priority to Taiwan Patent Application No. 104136011 filed on Nov. 2, 2015, which is hereby incorporated herein by reference in its entirety.

### FIELD

The present invention relates to a management system and method. More particularly, the present invention relates to a business process management system and method.

### BACKGROUND

Business process management (BPM) means that all or a part of production processes, purchase processes, administrative application processes, financial examination and approval processes, personnel handling processes, quality control processes, customer service processes or the like are processed by computer-related devices so that the processes are made simple and automated. For example, the business process modeling notation (BPMN) provides a kind of graphic representation for business process management. According to BPMN, the user may make the business process management by use of various business process models. Each business process model refers to a mesh-like map consisting of graphic objects, where the graphic objects include activities and flow controls for defining execution sequences of these activities.

The business process model must be executed by a corresponding business process management engine. The business process model generally comprises a plurality of process variables. During execution of the business process model, variable values corresponding to the process variables must be properly stored for the accessing of the corresponding business process management engine. Generally, the accessing speed of memories is higher than that of databases, but the probability of losing data is higher for memories than for databases. Therefore, for conventional business process management engines, each time a variable value corresponding to a process variable is generated during execution of a business process model, the variable value is stored to a database to prevent losing the variable value. Because the number of times of storing process variables to the database is directly proportional to the number of process variables, storing the process variables in the aforesaid way will take much time as the number of process variables increases.

Accordingly, an urgent need exists in the art to reduce the time taken by the conventional business process management engine to store the process variables.

### SUMMARY

The disclosure includes a business process management system. The business process management system in certain embodiments comprises a database, a memory device and a business process management engine connected with the database and the memory device. The database is configured to store a business process model and create storage fields in advance for a plurality of process variables comprised in the business process model according to at least one artifact corresponding to the business process model. The at least one artifact records an association between the process variables and the created storage fields. The business process management engine is configured to copy the business process model from the database to the memory device to execute the business process model in the memory device and configured to simultaneously store variable values corresponding to the process variables from the memory device to the created storage fields of the database according to the association during execution of the business process model.

The disclosure also includes a business process management method. The business process management method in certain embodiments comprises the following steps of: storing, by a database, a business process model; creating, by the database, storage fields in advance for a plurality of process variables comprised in the business process model according to at least one artifact corresponding to the business process model, the at least one artifact recording an association between the process variables and the created storage fields; copying, by a business process management engine, the business process model from the database to a memory device to execute the business process model in the memory device; and simultaneously storing, by the business process management engine, variable values corresponding to the process variables from the memory device to the created storage fields of the database according to the association during execution of the business process model by the business process management engine.

In certain embodiments, before a business process model is executed by a business process management engine, the business process management engine firstly copies the business process model from a database to a memory device to execute the business process model in the memory device. In addition, during execution of the business process model, a plurality of variable values corresponding to a plurality of process variables comprised in the business process model are temporarily stored by the memory device. Because the accessing speed of the memory device is higher than that of the database, these operations can not only increase the speed of executing the business process model by the business process management engine, but also reduce the time taken by the business process management engine to access the variable values during execution of the business process model.

On the other hand, before the business process model is executed by the business process management engine, the database may create storage fields in advance for a plurality of process variables comprised in the business process model according to at least one artifact of the business process model, and the at least one artifact may record an association between the process variables and the created storage fields. Thus, the business process management engine may simultaneously store the plurality of variable values corresponding to the process variables from the memory device to the created storage fields of the database according to the association during execution of the business process model. Because the business process management engine can store more than one variable value to the database at a time (e.g., store variable values corresponding to all the process variables comprised in the business process model to the database at a time), the time taken by the business process management engine to store the variable values to the database can be reduced. Furthermore, because the time taken to temporarily store the variable values to the memory device is reduced, the probability of losing the variable value in the memory device is also reduced.

This summary is not intended to contemplate all aspects of the present invention or limit the claims. Additionally, what described above is neither intended to identify key or essential elements of any or all aspects of the present invention, nor intended to describe the scope of any or all aspects of the present invention. This summary is provided only to present some concepts of some aspects of the present invention in a simple form and as an introduction to the following detailed description.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a block diagram illustrating an exemplary example of a business process management system according to one or more embodiments of the present invention.

FIG. 2 is a schematic view illustrating an exemplary example of a business process model according to one or more embodiments of the present invention.

FIG. 3 is a schematic view illustrating an exemplary example of an artifact shown in FIG. 2 according to one or more embodiments of the present invention.

FIG. 4 is a schematic view illustrating an exemplary example of overall operations of the business process management system shown in FIG. 1 according to one or more embodiments of the present invention.

FIG. 5 is a flowchart diagram illustrating an exemplary example of a business process management method according to one or more embodiments of the present invention.

### DETAILED DESCRIPTION

In the following description, certain aspects of the present invention will be explained with reference to example embodiments thereof. However, these example embodiments are not intended to limit the present invention to any specific examples, embodiments, environment, applications, structures, processes or steps described in these example embodiments.

In the attached drawings, elements unrelated to the present invention are omitted from depiction. Dimensional relationships among individual elements in the attached drawings are illustrated only for ease of understanding, but not to limit the actual scale. Unless otherwise stated, like reference numerals correspond to like elements.

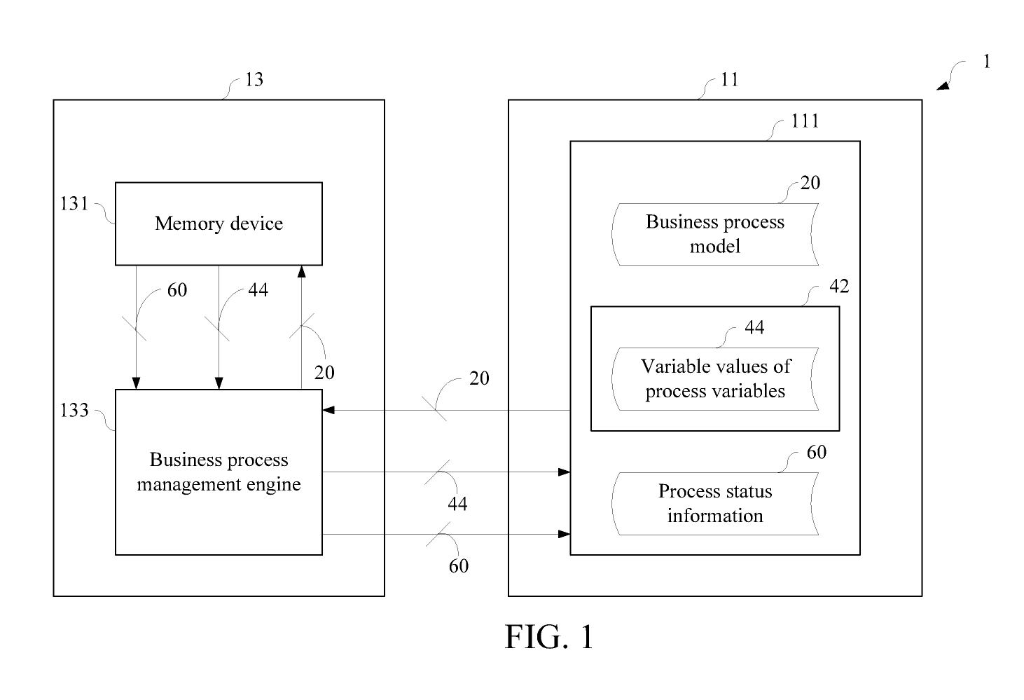

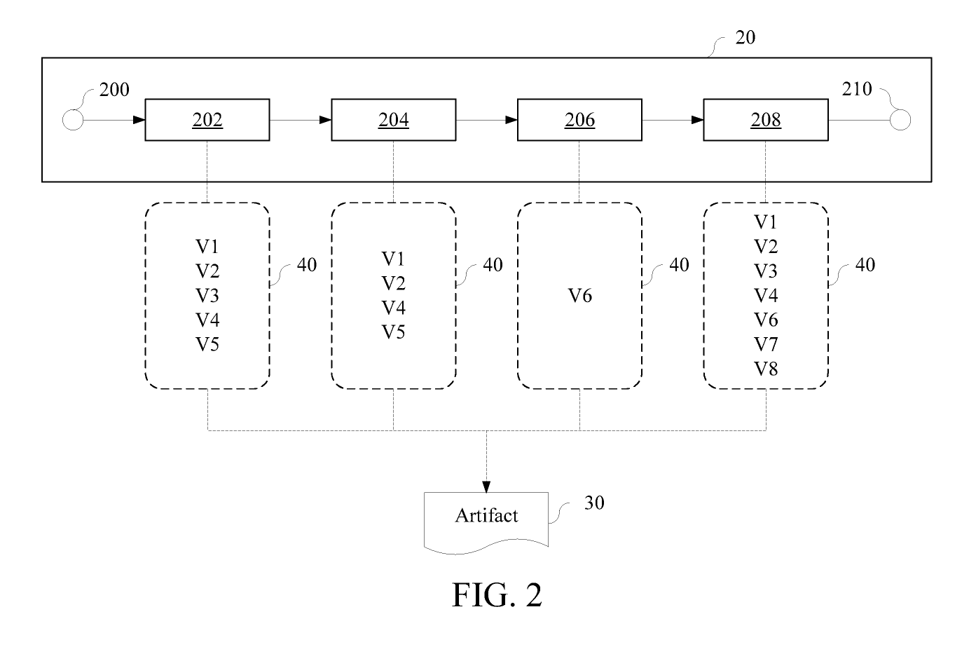

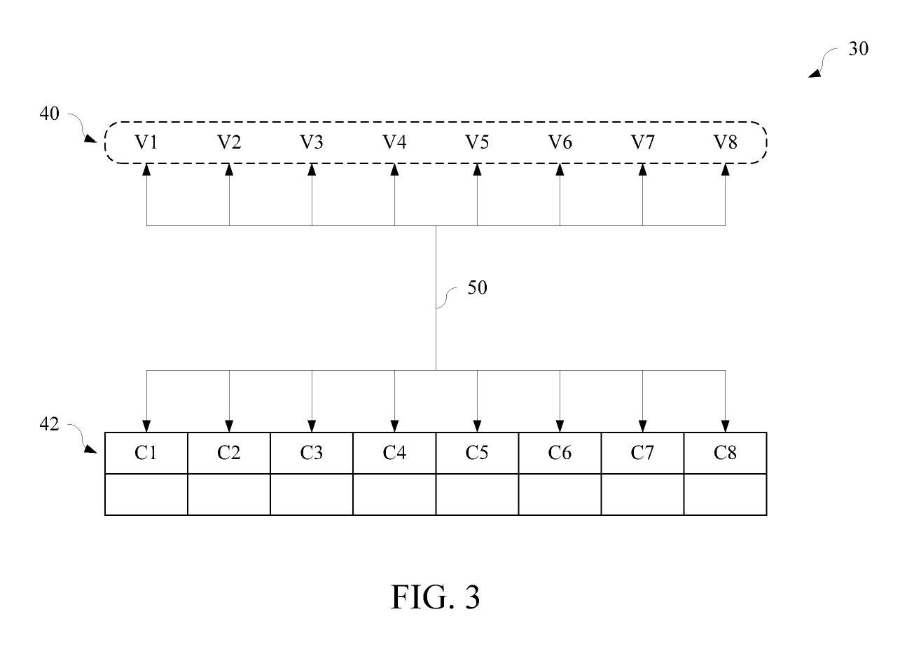

An embodiment of the present invention (called “the first embodiment” hereinafter) is a business process management system. FIG. 1 is a block diagram illustrating an exemplary example of a business process management system according to one or more embodiments of the present invention. FIG. 2 is a schematic view illustrating an exemplary example of a business process model according to one or more embodiments of the present invention. FIG. 3 is a schematic view illustrating an exemplary example of an artifact shown in FIG. 2 according to one or more embodiments of the present invention.

As shown in FIGS. 1˜3, the business process management system 1 may comprise a database 111, a memory device 131 and a business process management engine 133. In this embodiment, the database 111 is a part of a computer-related device 11, and the memory device 131 and the business process management engine 133 are parts of another computer-related device 13. The computer-related device 11 and the computer-related device 13 may connect with and communicate with each other via any of various wired or wireless networks, so the business process management engine 133 may be connected to and access the database 111 via any of various wired or wireless networks. The memory device 131 and the business process management engine 133 may be either directly or indirectly electrically connected with and communicate with each other. Herein, “directly electrically connected” means that the two components are electrically connected without any other intervening component therebetween, and “indirectly electrically connected” means that the two components are electrically connected with an intervening component therebetween.

In other embodiments, the database 111 may also be disposed in the computer-related device 13. That is, the database 111, the memory device 131 and the business process management engine 133 are parts of the computer-related device 13. In this case, the database 111, the memory device 131 and the business process management engine 133 may be either directly or indirectly electrically connected with and communicate with each other in the computer-related device 13.

The computer-related devices 11 and 13 may each be, for example but not limited to, a desktop computer, a laptop computer, a tablet computer, a notebook computer, a smartphone or the like. The computer-related devices 11 and 13 may each comprise a computing component such as a general-purpose processor or microprocessor, and execute various computations by use of this computing component. The computer-related devices 11 and 13 may each comprise a storage component such as a general-purpose memory and/or hard disk, and store various data in this storage component. The computer-related devices 11 and 13 may each comprise general-purpose input/output components, and receive incoming data and transmit outgoing data via the input/output components. The computer-related devices 11 and 13 may each execute corresponding operations described below via the computing component, the storage component, the input/output components or the like according to processes implemented by software, firmware, programs, algorithms or the like.

In this embodiment, the memory device 131 may be viewed as a storage component having a faster accessing speed but a higher probability of losing data stored therein, and the database 111 may be viewed as a storage component having a slower accessing speed but a lower probability of losing data stored therein. For example, the memory device 131 may be a memory, especially a volatile memory, in the computer-related device 13, while the database 111 may be a hard disk in the computer-related device 11. For the volatile memory (e.g., a random access memory (RAM)), data stored therein will be lost once the power supply is interrupted. The hard disk is a kind of nonvolatile storage component based on a hard rotary disk, so data stored therein can be saved even when the power supply is interrupted. Therefore, the memory can provide a higher accessing speed than the hard disk, but has a higher probability of losing the data stored therein than the hard disk (e.g., when the system comes to a halt or is turned off).

The database 111 may be used to store a business process model 20 (including the business process model 20 per se and various data thereof such as profiles/definitions). Depending on different needs, the business process model 20 may be implemented in different forms for use by the corresponding business process management engine 133. For example, the business process model 20 may conform to one of the business process modeling notation (BPMN) and the business process execution language (BPEL). The business process model 20 may be a product obtained through conversion from any kind of process models. As an example, at the development stage, a developer may create a process model via various process plotting tools and depending on the need, and then by means of a conventional business process model conversion technology, convert the process model into the business process model 20 conforming to BPMN or BPEL and store the business process model 20 into the database 111.

The business process model 20 may comprise a plurality of stages (or called steps or processes), each of which may be connected to another or other stages via various activities and/or conditions. Taking FIG. 2 as an example, the business process model 20 may comprise an initial stage 200, a plurality of intermediate stages 202˜208 and an end stage 210. The initial stage 200 refers to a stage in which the business process model 20 is initialized, and the end stage 210 refers to a stage in which the business process model 20 is ended. The intermediate stages 202˜208 refer to stages between the initial stage 200 and the end stage 210 of the business process model 20.

In each of the stages of the business process model 20, there may be a corresponding process variable 40 that needs to be processed, and all the process variables 40 comprised in the business process model 20 may be recorded in at least one artifact (i.e., one or more artifacts). A single artifact 30 may be used to record all the process variables 40 that need to be processed in the stages, or a plurality of artifacts 30 may be used to record all the process variables 40 that need to be processed in the stages.

Taking FIG. 2 as an example, the process variables 40 that need to be processed in the intermediate stage 202 may include process variables V1, V2, V3, V4, V5; the process variables 40 that need to be processed in the intermediate stage 204 may include process variables V1, V2, V4, V5; the process variables 40 that need to be processed in the intermediate stage 206 may include a process variable V6; the process variables 40 that need to be processed in the intermediate stage 208 may include process variables V1, V2, V3, V4, V6, V7, V8. Optionally in the initial stage 200, all the process variables 40 comprised in the business process model 20 may be initialized, so the process variables 40 that need to be processed in this stage may include process variables V1˜V8. Additionally, in FIG. 2, a single artifact 30 may be used to record all the process variables V1˜V8 that need to be processed.

As an exemplary example, assume that the business process model 20 shown in FIG. 2 is a purchasing-related business process model. Then the intermediate stage 202 may be a goods ordering stage, the intermediate stage 204 may be a price calculating stage, the intermediate stage 206 may be a check-out website connecting stage, and the intermediate stage 208 may be a checkout stage. In this exemplary example, the process variables V1˜V8 may correspond to the number of pieces of goods, the price, the product name, the product list, the description, the check-out website, the ordering status, and the check-out time respectively.

In addition to storing the business process model 20, the database 111 may be further configured to create storage fields 42 in advance for a plurality of process variables 40 (or all the process variables 40) comprised in the business process model 20 according to at least one artifact 30 (i.e., one or more artifacts) corresponding to the business process model 20. Generally, access to data of a database is limited to the mechanism of accessing row by row (i.e., accessing row by row from top to bottom). Therefore, the created storage fields 42 may be arranged horizontally (e.g., the storage fields C1˜C8 shown in FIG. 3) in the database 111 so that the business process management engine 133 can simultaneously (i.e., a plurality of variable values at a time) store the variable values corresponding to the process variables 40 from the memory device 131 to the created storage fields 42 (to be detailed later).

The database 111 may create the storage fields 42 in advance for the plurality of process variables 40 comprised in the business process model 20 according to any of various conventional method of creating variable fields. For example, the database 111 may create the storage fields 42 in advance for the process variables 40 comprised in the business process model 20 according to a data manipulation language (DML). The process of creating the storage fields 42 in advance may include but is not limited to: specify the locations of the storage fields 42 in the database 111, and specify data types (e.g., numeric values, strings or the like) corresponding to the storage fields 42. DML is an instruction set responsible for executing data accessing operations on database objects in a structured query language (SQL), and has the INSERT instruction, the UPDATE instruction and the DELETE instruction as its core instructions. These three instructions plus the SELECT instruction of SQL are generally called the four basic database operations (Creating, Reading, Updating and Deleting; CRUD).

The artifact 30 may be used to record an association 50 between the process variables 40 and the created storage fields 42. Taking FIG. 3 as an example, assume that all the process variables 40 comprised in the business process model 20 are process variables V1˜V8, and the storage fields 42 created by the database 111 in advance for the process variables V1˜V8 are storage fields C1˜C8. Then, the artifact 30 may record an association 50 between the process variables V1˜V8 and the storage fields C1˜C8. According to the association 50, each of the process variables V1˜V8 may correspond to one fixed storage field in the database 111, i.e., correspond to one of the storage fields C1˜C8. For example, the process variables V1˜V8 may correspond to the storage fields C1˜C8 respectively. In other words, the storage field C1 may be used to store data of the process variable V1, the storage field C2 may be used to store data of the process variable V2, . . . , and the storage field C8 may be used to store data of the process variable V8. After the database 111 has stored the business process model 20 therein and created the storage fields 42 in advance, the business process management engine 133 which is to execute the business process model 20 may copy the business process model 20 from the database 111 to the memory device 131 to execute the business process model 20 in the memory device 131. Because the accessing speed of the memory device 131 is higher than that of the database 111, executing the business process model 20 in the memory device 131 can not only increase the speed of executing the business process model 20 by the business process management engine 133, but also reduce the time taken by the business process management engine 133 to access the variable values 44 during execution of the business process model 20.

Furthermore, during execution of the business process model 20, the business process management engine 133 may simultaneously (i.e., a plurality of variable values at a time) store the plurality of variable values 44 corresponding to the process variables 40 from the memory device 131 to the created storage fields 42 of the database 111 according to the association 50. Because the storage fields 42 corresponding to the process variables 40 have been created in advance and the artifact 30 has recorded the association 50 between the process variables 40 and the created storage field 42, the time taken by the business process management engine 133 to store the variable values 44 to the database 111 can be reduced. Additionally, because the time taken to temporarily store the variable values 44 to the memory device 131 is reduced, the probability of losing the variable values 44 in the memory device 131 is also reduced.

The variable values 44 may be stored to the created storage fields 42 of the database 111 by the business process management engine 133 according to any of various variable storage methods. For example, the variable values 44 may be stored to the created storage fields 42 of the database 111 by the business process management engine 133 according to the aforesaid DML (e.g., the four basic operations of CRUD).

As described above, the business process model 20 may comprise a plurality of stages (e.g., the stages 200˜210 shown in FIG. 2). In this case, the business process management engine 133 may store the variable values 44 from the memory device 131 to the created storage fields in any of the stages. Taking FIG. 2 as an example, assume that the process variables V1, V2, V4, V5 are processed by the business process management engine 133 at the intermediate stage 204 to result in a plurality of corresponding variable values 44. Then, the business process management engine 133 may store the variable values 44 corresponding to the process variables V1, V2, V4, V5 from the memory device 131 to the corresponding storage fields 42 of the database 111 simultaneously (i.e., a plurality of variable values at a time) at the intermediate stage 204. Optionally, in addition to the variable values 44 corresponding to the process variables V1, V2, V4, V5, variable values 44 corresponding to other process variables (e.g., the process variable V3) may also be stored by the business process management engine 133 from the memory device 131 to the corresponding storage fields 42 of the database 111 at the intermediate stage 204. Optionally, the business process management engine 133 may also store only two variable values 44 corresponding to the process variables V1, V2 from the memory device 131 to the corresponding storage fields 42 of the database 111 at the intermediate stage 204. Briefly speaking, the business process management engine 133 may store variable values 44 (including initial variable values and actual variable values) corresponding to one or more of the process variables V1˜V8 from the memory device 131 to the corresponding storage fields 42 of the database 111 at any of the stages of the business process model 20 depending on different needs.

The business process management engine 133 may also store a plurality of pieces of process status information 60 from the memory device 131 to the database 111 simultaneously according to an SQL during execution of the business process model 20. The process status information 60 may comprise various pieces of information generated during execution of the business process model 20. As described above, the business process model 20 may comprise a plurality of stages (e.g., the stages 200˜210 shown in FIG. 2). In this case, the business process management engine 133 may store a plurality of pieces of process status information 60 from the memory device 131 to the database 111 simultaneously at any of the stages. Briefly speaking, the business process management engine 133 may store a plurality of pieces of process status information 60 (including newly generated process status information and updated process status information) from the memory device 131 to the database 111 at any of the stages of the business process model 20 depending on different needs.

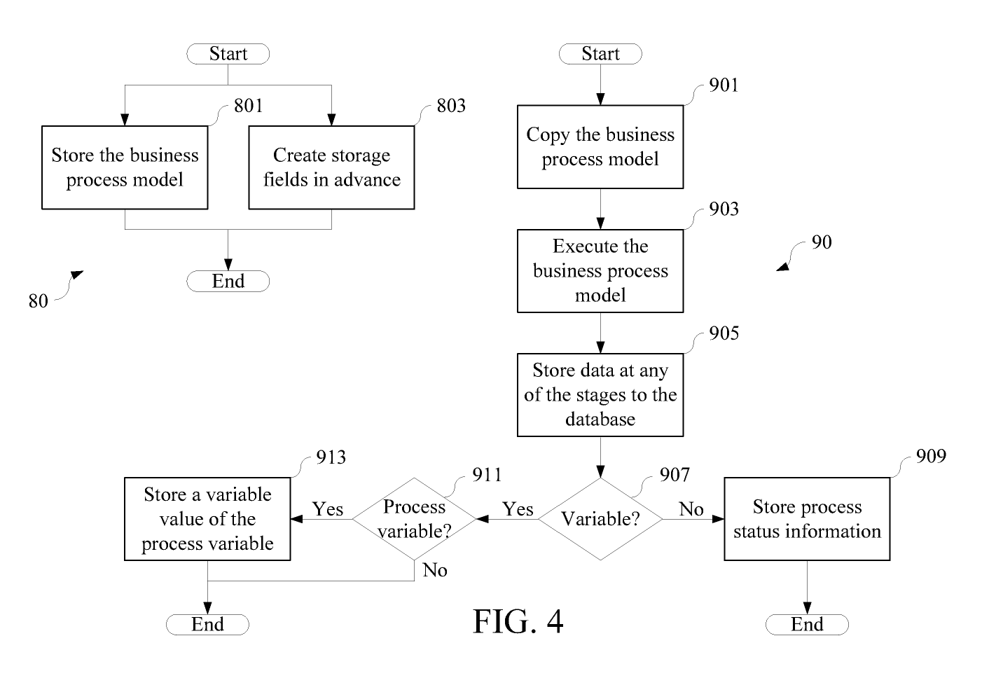

Hereinafter, FIG. 4 will be taken as an exemplary example to describe overall operations of the business process management system 1, although the present invention is not limited to this exemplary example. FIG. 4 is a schematic view illustrating an exemplary example of overall operations of the business process management system 1 shown in FIG. 1 according to one or more embodiments of the present invention. As shown in FIG. 4, the business process management system 1 may comprise a development status 80 and an execution status 90. The development status 80 refers to the status existing before the business process management engine 133 starts to execute the business process model 20, and the execution status 90 refers to the status existing after the business process management engine 133 has started to execute the business process model 20 and during execution of the business process model 20.

In the development status 80, a developer may create a process model via a process plotting tool depending on the need, convert the process model into the business process model 20 conforming to definitions (e.g., BPMN or BPEL) that can be executed by the business process management engine 133, and store the business process model 20 to the database 111 (indicated by 801). In the development status 80, the developer may also define at least one artifact 30 used to record the plurality of process variables 40 comprised in the business process model 20; and the developer may create corresponding process fields 42 in advance in the database 111 for the plurality of process variables 40 according to the aforesaid DML (e.g., the four basic operations of CRUD) (indicated by 803).

In the execution status 90, when the business process management engine 133 begins to execute the business process model 20, the business process management engine 133 may firstly copy the business process model 20 from the database 111 to the memory device 131 (indicated by 901). Then, the business process management engine 133 may execute the business process model 20 in the memory device 131 (indicated by 903). When the business process management engine 133 starts to execute the business process model 20, the business process model 20 may be firstly initialized to add the plurality of process variables 40 comprised in the business process model 20 and necessary information (e.g., the process status information 60) into the memory.

The business process management engine 133 may comprise a data management module (not depicted). At any stage (e.g., any of the stages 200˜210 shown in FIG. 2) during execution of the business process model 20 by the business process management engine 133, the data management module may decide whether to store data from the memory device 131 to the database 111 (indicated by 905). If it is decided to store data to the database 111 at any of the stages, the data management module may further determine whether the data to be stored is a variable (indicated by 907). If the determination result is “no”, the data management module may convert the plurality of pieces of process status information 60 recorded in the memory device 131 piece by piece according to the aforesaid SQL, and then store the plurality of pieces of process status information 60 from the memory device 131 to the database 111 simultaneously (i.e., a plurality of pieces at a time) (indicated by 909) to reduce the time that would otherwise be consumed by multiple times of storage operations.

If the determination result is “yes”, the data management module may further determine whether the data to be stored is a process variable (indicated by 911). If the determination result in 911 is “yes”, the data management module may store the plurality of variable values 44 corresponding to the process variables 40 from the memory device 131 to the created storage fields 42 of the database 111 simultaneously (i.e., a plurality of variable values at a time) according to the association 50 and the aforesaid DML (e.g., the four basic operations of CRUD) (indicated by 913). If the determination result in 911 is “no”, the data management module may not process the variable or may only routinely process the variable. Optionally, the business process management engine 133 may execute querying, modifying, deleting or other operations on the process variables 40 and the plurality of pieces of process status information 60 during execution of the business process model 20.

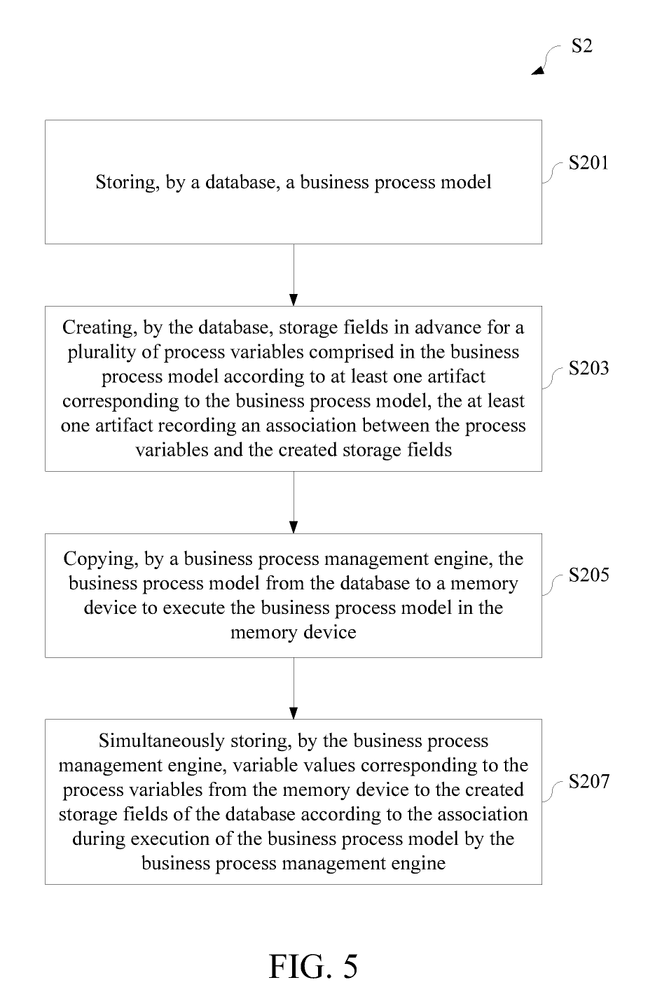

Another embodiment (called “the second embodiment” hereinafter) of the present invention is a business process management method. FIG. 5 is a flowchart diagram illustrating an exemplary example of a business process management method according to one or more embodiments of the present invention. Sequences of all steps described in the second embodiment and exemplary examples thereof can be arbitrarily adjusted without departing from the spirits of the present invention and shall not be construed to limit the scope of the present invention.

As shown in FIG. 5, the business process management method S2 may comprise the following steps: storing, by a database, a business process model (step S201); creating, by the database, storage fields in advance for a plurality of process variables comprised in the business process model according to at least one artifact corresponding to the business process model, the at least one artifact recording an association between the process variables and the created storage fields (step S203); copying, by a business process management engine, the business process model from the database to a memory device to execute the business process model in the memory device (step S205); and simultaneously storing, by the business process management engine, variable values corresponding to the process variables from the memory device to the created storage fields of the database according to the association during execution of the business process model by the business process management engine (step S207).

As an exemplary example of the second embodiment, in the business process management method S2, the storage fields may be created in advance by the database according to a data manipulation language (DML), and the business process management engine may store the variable values from the memory device to the created storage fields according to the DML.

As an exemplary example of the second embodiment, in the business process management method S2, the business process model may comprise a plurality of stages, and the business process management engine may store the variable values from the memory device to the created storage fields at any of the stages.

As an exemplary example of the second embodiment, in the business process management method S2, the business process model conforms to one of a business process modeling notation (BPMN) and a business process execution language (BPEL).

As an exemplary example of the second embodiment, the business process management method S2 may further comprise the following step: storing, by the business process management engine, a plurality of pieces of process status information from the memory device to the database simultaneously (i.e., a plurality of pieces at a time) according to a structured query language (SQL) during execution of the business process model by the business process management engine.

As an exemplary example of the second embodiment, the business process management method S2 may further comprise the following step: storing, by the business process management engine, a plurality of pieces of process status information from the memory device to the database simultaneously (i.e., a plurality of pieces at a time) according to a structured query language (SQL) during execution of the business process model by the business process management engine. Besides, the business process model may comprise a plurality of stages, and the business process management engine may simultaneously (i.e., a plurality of pieces at a time) store the plurality of pieces of process status information from the memory device to the database at any of the stages.

The business process management method S2 substantially comprises steps corresponding to all operations of the business process management system 1. Because all the corresponding steps comprised in the business process management method S2 can be readily known by those of ordinary skill in the art from the descriptions of the business process management system 1, these corresponding steps will not be further described herein.

According to the above descriptions of the present invention, before a business process model is executed by a business process management engine, the business process management engine firstly copies the business process model from a database to a memory device to execute the business process model in the memory device, and during execution of the business process model, a plurality of variable values corresponding to a plurality of process variables comprised in the business process model are temporarily stored by the memory device. Because the accessing speed of the memory device is higher than that of the database, these operations can not only increase the speed of executing the business process model by the business process management engine, but also reduce the time taken by the business process management engine to access the variable values during execution of the business process model.

On the other hand, before the business process model is executed by the business process management engine, the database may create storage fields in advance for a plurality of process variables comprised in the business process model according to at least one artifact of the business process model, and the at least one artifact may record an association between the process variables and the created storage fields. Thus, the business process management engine may simultaneously store the plurality of variable values corresponding to the process variables from the memory device to the created storage fields of the database according to the association during execution of the business process model. Because the business process management engine can store more than one variable value to the database at a time (e.g., store variable values corresponding to all the process variables comprised in the business process model to the database at a time), the time taken by the business process management engine to store the variable values to the database can be reduced. Furthermore, because the time taken to temporarily store the variable values to the memory device is reduced, the probability of losing the variable value in the memory device is also reduced.

The above disclosure is related to the detailed technical contents and inventive features thereof. People skilled in this field may proceed with a variety of modifications and replacements based on the disclosures and suggestions of the invention as described without departing from the characteristics thereof. Although such modifications and replacements are not fully disclosed in the above descriptions, they have substantially been covered in the following claims as appended.

What is claimed is:

1. A business process management system, comprising:
a database, being configured to store a business process model and create storage fields in advance for a plurality of process variables comprised in the business process model according to at least one artifact corresponding to the business process model, the at least one artifact recording an association between the process variables and the created storage fields;
a memory device; and
a business process management engine connected with the database and the memory device, being configured to copy the business process model from the database to the memory device to execute the business process model in the memory device and configured to simultaneously store variable values corresponding to the process variables from the memory device to the created storage fields of the database according to the association during execution of the business process model.

2. The business process management system of claim 1, wherein the storage fields are created in advance by the database according to a data manipulation language (DML), and the business process management engine stores the variable values from the memory device to the created storage fields according to the DML.

3. The business process management system of claim 1, wherein the business process model comprises a plurality of stages, and the business process management engine stores the variable values from the memory device to the created storage fields at any of the stages.

4. The business process management system of claim 1, wherein the business process model conforms to one of a business process modeling notation (BPMN) and a business process execution language (BPEL).

5. The business process management system of claim 1, wherein the business process management engine further stores a plurality of pieces of process status information from the memory device to the database simultaneously according to a structured query language (SQL) during execution of the business process model.

6. The business process management system of claim 5, wherein the business process model comprises a plurality of stages, and the business process management engine stores the plurality of pieces of process status information from the memory device to the database at any of the stages.

7. A business process management method, comprising the following steps of:
storing, by a database, a business process model;
creating, by the database, storage fields in advance for a plurality of process variables comprised in the business process model according to at least one artifact corresponding to the business process model, the at least one artifact recording an association between the process variables and the created storage fields;
copying, by a business process management engine, the business process model from the database to a memory device to execute the business process model in the memory device; and
simultaneously storing, by the business process management engine, variable values corresponding to the process variables from the memory device to the created storage fields of the database according to the association during execution of the business process model by the business process management engine.

8. The business process management method of claim 7, wherein the storage fields are created in advance by the database according to a data manipulation language (DML), and the business process management engine stores the variable values from the memory device to the created storage fields according to the DML.

9. The business process management method of claim 7, wherein the business process model comprises a plurality of stages, and the business process management engine stores the variable values from the memory device to the created storage fields at any of the stages.

10. The business process management method of claim 7, wherein the business process model conforms to one of a business process modeling notation (BPMN) and a business process execution language (BPEL).

11. The business process management method of claim 7, further comprising the following step of:
storing, by the business process management engine, a plurality of pieces of process status information from the memory device to the database simultaneously according to a structured query language (SQL) during execution of the business process model by the business process management engine.

12. The business process management method of claim 11, wherein the business process model comprises a plurality of stages, and the business process management engine simultaneously stores the plurality of pieces of process status information from the memory device to the database at any of the stages.
